(19) United States
(12) Patent Application Publication
(10) Pub. No.: US 2015/0116292 A1
(43) Pub. Date: Apr. 30, 2015

(54) DISPLAY DEVICE AND METHOD FOR DRIVING THE SAME

(71) Applicant: SAMSUNG DISPLAY CO., LTD., Yongin-City (KR)

(72) Inventors: DONG-HYUN YEO, Yongin-si (KR); Su Hyun Jeong, Gwangju-si (KR); Yong-Bum Kim, Suwon-si (KR); Byung Kil Jeon, Asan-si (KR)

(73) Assignee: SAMSUNG DISPLAY CO., LTD., Yongin-City (KR)

(21) Appl. No.: 14/255,671

(22) Filed: Apr. 17, 2014

(30) Foreign Application Priority Data
Oct. 25, 2013 (KR) 10-2013-0128080

(51) Int. Cl. G09G 3/20

(52) U.S. Cl. CPC G09G 3/20
USPC 345/204

(57) ABSTRACT

A display device includes a display panel and a signal controller. The signal controller receives an input signal and controls an operation of the display panel. The signal controller controls the display panel to display different images according to different types of a fail when determining the fail in the input signal.

### CROSS-REFERENCE TO RELATED APPLICATION

This application claims priority to Korean Patent Application No. 10-2013-0128080 filed on Oct. 25, 2013, the disclosure of which is incorporated by reference herein in its entirety.

### TECHNICAL FIELD

Exemplary embodiments of the present invention relates to displays, and more specifically, to a display device and a method of driving the same.

### DISCUSSION OF THE RELATED ART

A signal controller, e.g., a timing controller, controls the timing of an image signal and a control signal and provides the controlled signals to a display panel. When an abnormal signal is input to the signal controller, an error may occur in a displayed image. A user may not know what causes such an error.

### SUMMARY

An exemplary embodiment of the present invention provides a display device. The display device includes a display panel and a signal controller. The signal controller receives an input signal and controls an operation of the display panel. The signal controller may control the display panel to display different images according to different types of a fail when determining the fail in the input signal.

The input signal may include an image signal and a control signal generated by a graphic processing unit.

The signal controller may include a receiving unit receiving the image signal and the control signal from the graphic processing unit. A fail detecting unit detects the fail in the received image signal and control signal to generate a fail signal. An image processor outputs image data in a fail mode when receiving the fail signal.

The fail signal may have different types according to the different types of the fail.

The type of the fail may include a clock fail, a line fail, a line total fail, a frame fail, a frame total fail, an ESD line fail, or a phase2 fail.

The fail detecting unit may include a plurality of detecting units which respectively detects different types of fails to generate different fail signals, respectively.

The image may include a still image.

The image may have different colors according to the different types of the fail.

The image may have different patterns according to the different types of the fail.

The image may have the same pattern and different colors according to the different types of the fail.

The image may remain same regardless of the type of the fail.

An exemplary embodiment of the present invention provides a method of driving a display device. The display device includes receiving an input signal by the signal controller. A fail in the input signal is detected, generating a fail signal by the signal controller. The display panel displays an image according to a fail type by the signal controller.

The input signal may include an image signal and a control signal generated by a graphic processing unit.

Detecting the fail in the input signal may include comparing the input signal with reference data stored in an external storing unit.

The fail signal may have different types according to the different types of the fail.

The type of the fail may include a clock fail, a line fail, a line total fail, a frame fail, a frame total fail, an ESD line fail, or a phase2 fail.

The image may include a still image.

The image may have different colors according to the different types of the fail.

The image may have different patterns according to the different types of the fail.

The image may have the same pattern and different colors according to the different types of the fail.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram of a display device according to an exemplary embodiment of the present invention;

FIG. 2 is an equivalent circuit diagram of a pixel in a display device according to an exemplary embodiment of the present invention;

FIG. 3 is a block diagram illustrating a structure of a signal controller of a display device according to an exemplary embodiment of the present invention;

FIG. 4 is a waveform diagram of a data enable signal for describing a fail of an input signal, according to an exemplary embodiment of the present invention;

FIG. 5 is a table illustrating fail types and detection conditions thereof, according to an exemplary embodiment of the present invention;

FIG. 6 is a flowchart illustrating a method in which a display device operates in a fail mode according to an exemplary embodiment of the present invention;

FIG. 7 is a diagram illustrating an example of a display image for each fail type according to an exemplary embodiment of the present invention;

FIG. 8 is a diagram illustrating an example of a display image for each fail type according to an exemplary embodiment of the present invention; and

FIG. 9 is a diagram illustrating an example of a display image for each fail type according to an exemplary embodiment of the present invention.

### DETAILED DESCRIPTION OF EMBODIMENTS

Hereinafter, exemplary embodiments of the present invention will be described in detail with reference to the accompanying drawings. The present invention, however, may be modified in various different ways, and should not be construed as limited to the embodiments set forth herein. The same reference numerals may be used to denote the same or substantially the same elements throughout the specification and the drawings. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

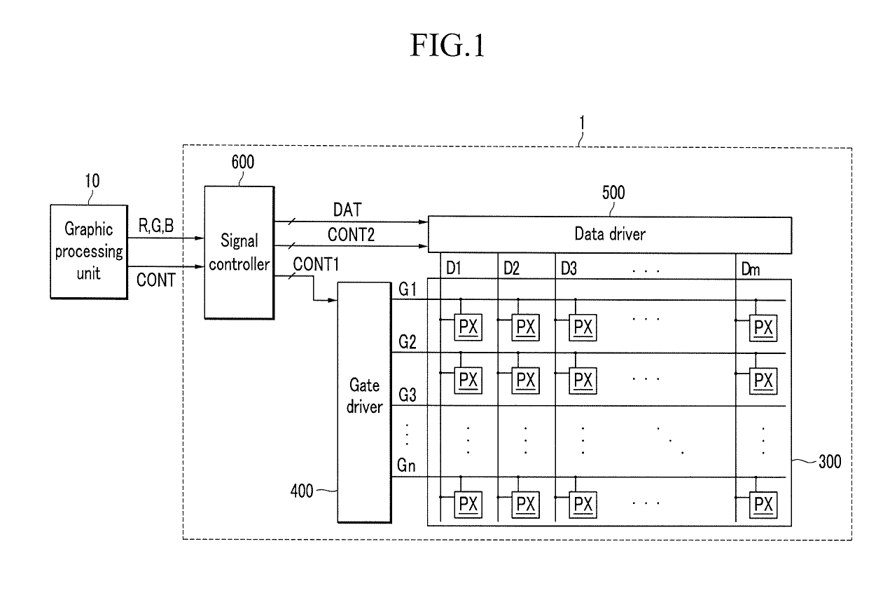

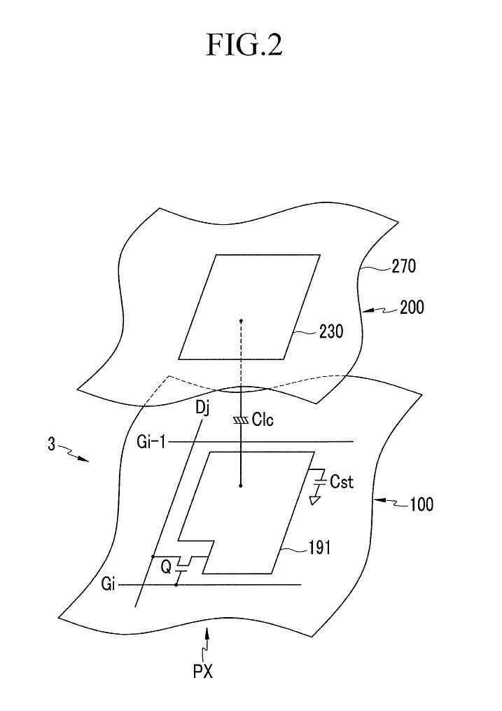

FIG. 1 is a block diagram of a display device according to an exemplary embodiment of the present invention, and FIG. 2 is an equivalent circuit diagram of a pixel in a display device according to an exemplary embodiment of the present invention.

As illustrated in FIG. 1, a display device 1 includes a display panel 300 for displaying an image, a gate driver 40, a data driver 500, and a signal controller 600. As shown in FIG. 1, a graphic processing unit 10 is positioned outside the display device 1.

The graphic processing unit 10 provides image signals R, G, and B and a control signal CONT to the signal controller 600 of the display device 1. The control signal CONT includes a horizontal synchronization signal Hsync, a vertical synchronization signal Vsync, a clock signal CLK, a data enable signal DE, and the like. The image signals R, G, and B and the control signal CONT may be transmitted to the signal controller 600 by a low voltage differential signaling (LVDS) method.

The display panel 300 includes lower and upper panels 100 and 200 facing each other, and a liquid crystal layer 3 interposed therebetween. The display panel 300 includes a plurality of gate lines G1-Gn and a plurality of data lines D1-Dm. The plurality of gate lines G1-Gn is extended substantially in a horizontal direction of the display panel 300, and the plurality of data lines D1-Dm is extended substantially in a vertical direction of the display panel 300 and crosses the plurality of gate lines G1-Gn. The data lines D1-Dm may be electrically insulated from the gate lines G1-Gn.

One of the gate lines G1-Gn and one of the data lines D1-Dm are connected with one pixel PX. The pixels PX are arranged in a matrix form, and each pixel PX may include a thin film transistor Q, a liquid crystal capacitor Clc, and a storage capacitor Cst. A control terminal of the thin film transistor Q is connected to one of the gate lines G1-Gn, an input terminal of the thin film transistor Q is connected to one of the data lines D1-Dm, and an output terminal of the thin film transistor Q may be connected to a pixel electrode 191 which is one terminal of the liquid crystal capacitor Clc and one terminal of the storage capacitor Cst. The other terminal of the liquid crystal capacitor Clc is connected to a common electrode 270, and the other terminal of the storage capacitor Cst may receive a storage voltage. Both the pixel electrode 191 and the common electrode 270 may be positioned on the lower panel 100 according to a type of display panel 300.

According to the exemplary embodiment of the present invention, the pixels PX in one row may be alternately connected to a pair of gate lines positioned thereabove and therebelow. For example, one of the gate lines G1-Gn may be alternately connected to a pixel positioned at an upper side of the gate line and a pixel positioned at a lower side of the gate line. According to such a structure, an odd numbered pixel and an even numbered pixel included in one pixel row may be connected to different gate lines from each other. In this case, the data lines D1-Dm are connected with pixels, respectively, positioned along one column.

The signal controller 600 receives input image signals R, G, and B, and control signals CONT, which include a horizontal synchronization signal Hsync, a vertical synchronization signal Vsync, a clock signal CLK, and a data enable signal DE, from the external graphic processing unit 10. The signal controller 600 processes the image signals R, G, and B in accordance with an operation condition of the display panel 300 based on the image signals R, G, and B and the control signals CONT and generates and outputs image data DAT, a gate control signal CONT1, a data control signal CONT2, and a clock signal.

When the image signals R, G, and B and the control signals CONT input form the graphic processing unit 10 are abnormal (this may be also referred to as a “fail”), the signal controller 600 detects the fail and outputs a signal that controls the display panel 300 to display a distinct image according to a fail type.

The gate control signal CONT1 includes a start pulse vertical signal (STV) for instructing the start of scanning and a clock pulse vertical signal (CPV) which is a reference for generation of a gate-on voltage. An output period of the start pulse vertical signal (STV) may be one frame (or a refresh rate). The gate control signal CONT1 may further include an output enable signal OE for limiting the duration of the gate-on voltage Von.

The data control signal CONT2 includes a start pulse horizontal signal STH for instructing the start of transmission of the image data DAT for a row of pixels, a load signal TP for instructing a corresponding data voltage to be applied to the data lines D1-Dm. The data control signal CONT2 may further include a reverse signal RVS for reversing a polarity of the data voltage for a common voltage Vcom.

The plurality of gate lines G1-Gn of the display panel 300 is connected with the gate driver 400, and gate-on voltages Von are sequentially applied according to the gate control signal CONT1 applied from the signal controller 600, and a gate-off voltage Voff is applied when the gate-on voltages Von are not applied.

The plurality of data lines D1-Dm of the display panel 300 is connected with the data driver 500, and the data driver 500 receives the data control signal CONT2 and the image data DAT from the signal controller 600. The data driver 500 converts image data DAT into a data voltage by using a gray voltage generated in a gray voltage generator (not illustrated) and transfers the data voltage to the data lines D1-Dm. The data voltage includes a data voltage having a positive polarity and a data voltage having a negative polarity. The data voltage having a positive polarity and the data voltage having a negative polarity are alternately applied based on a frame and a row and/or a column, and thus reverse driving may be performed.

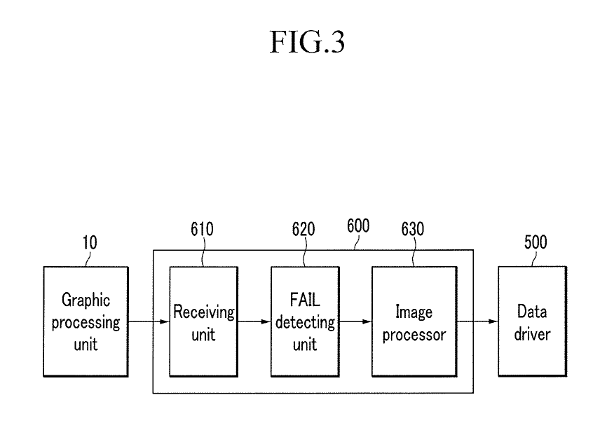

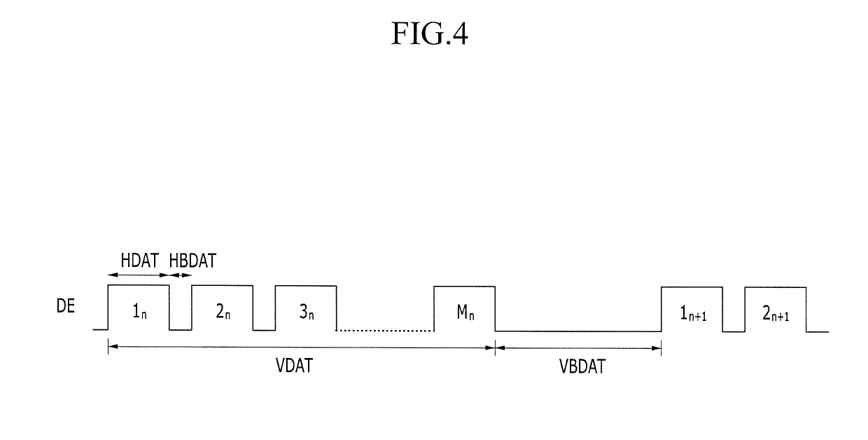

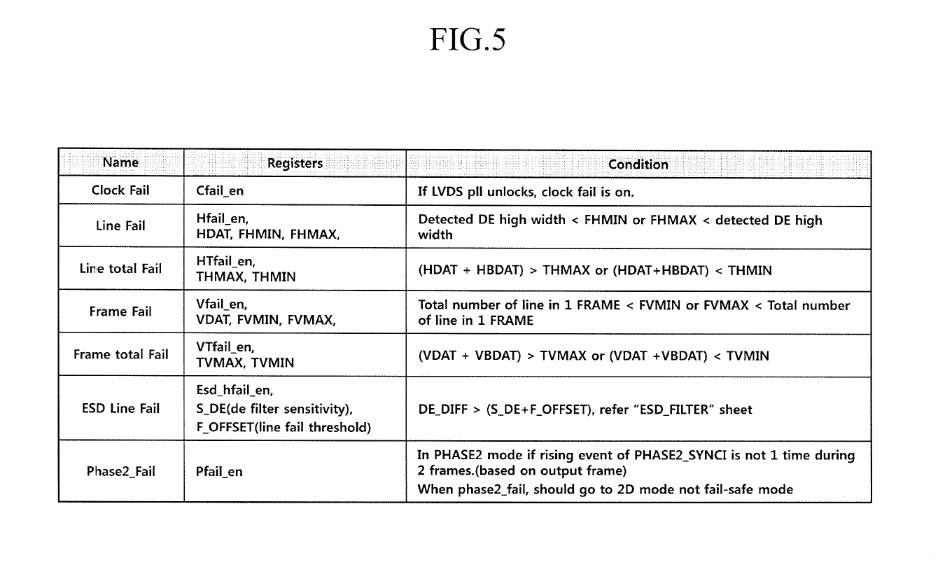

FIG. 3 is a block diagram illustrating a structure of a signal controller of a display device according to an exemplary embodiment of the present invention. FIG. 4 is a waveform diagram of a data enable signal for describing a fail of an input signal, according to an exemplary embodiment of the present invention. FIG. 5 is a table illustrating fail types and detection conditions thereof, according to an exemplary embodiment of the present invention.

The signal controller 600 includes a receiving unit 610, a fail detecting unit 620, and an image processor 630. The signal controller 600 receives a signal from the external graphic processing unit 10 of the display device 1, provides the gate control signal CONT1 to the gate driver 400 of the display device, and provides the image data DAT and the data control signal CONT2 to the data driver 500.

The receiving unit 610 receives the image signals R, G, and B and the control signal CONT from the external graphic processing unit 10 of the display device and transmits the received image signals R, G, and B and control signal CONT to the fail detecting unit 620. The receiving unit 610 may lower voltage levels of the image signals R, G, and B and the control signal CONT and increase frequencies, by using, for example, a low voltage differential signaling (LVDS) method, a transition minimized differential signaling (TMDS) method, and the like. The receiving unit 610 may convert the image signals R, G, and B and the control signal CONT to be suitable for a format in the signal controller 600.

The fail detecting unit 620 checks and detects whether the received image signals and control signal are failed, and the fail detecting unit 620 generates a fail signal when detecting the fail and transfers the generated fail signal to the image processor 630. The term “fail” means when the received image signals are not suitable for a predetermined standard or when the control signal is abnormal. When the signal is failed, the signal controller 600 may perform abnormal driving, and the image displayed on the display panel may be deteriorated.

The fail detecting unit 620 compares the image signals R, G, and B and the control signal CONT with reference data read from, e.g., an external storing unit (not illustrated) and generates a fail signal when the image signals R, G, and B and the control signal CONT are different from the reference data. The fail detecting unit 620 may be configured as a built-in self-test (BIST) circuit.

The fail detecting unit 620 may detect a clock fail, a line fail, a line total fail, and a frame total fail as illustrated in FIG. 5, and may further detect an ESD line fail and/or a phase2 fail. The fail detecting unit 620 may include a plurality of detecting units which detects different types of fails and generates different fail signals. The various types of fails may be detected by analyzing a data enable signal as illustrated in FIG. 4.

The clock fail means when the clock signal CLK is not applied from the graphic processing unit 10. The fail detecting unit 620 may output a clock fail signal when detecting the clock fail. The fail detecting unit 620 checks whether the clock signal is the same as a reference parameter stored in the external storing unit and may output the clock fail signal when the clock signal is not the same as the reference parameter.

The line fail means when a high period HDAT of the data enable signal DE is not maintained for a predetermined period. The fail detecting unit 620 may output a line fail signal when detecting the line fail. For example, when the display panel has a full high definition (HD) resolution of 1920×1080, the high period HDAT of the data enable signal DE may be a period corresponding to 960. The external storing unit may store a minimum value and a maximum value of the period during which the high period HDAT of the data enable signal DE is maintained. The fail detecting unit 620 may output the line fail signal when the high period HDAT of the data enable signal DE does not exist between the minimum value and the maximum value stored in the external storing unit.

The line total fail means when a sum of the high period HDAT and a low period HBDAT of the data enable signal DE is not maintained for a predetermined period, and in this case, the fail detecting unit 620 may output a line total fail signal.

The frame fail means when the data enable signal DE is not maintained for a predetermined period in a frame period VDAT, and the fail detecting unit 620 may output a frame fail signal when the frame fail is detected. For example, when the display panel has a full HD resolution, the data enable signal DE has, e.g., 1080 pluses in the frame period VDAT. The external storing unit may store a minimum value and a maximum value of the period when the data enable signal DE is maintained in the frame period VDAT.

The frame total fail means when a sum of the frame period VDAT of the data enable signal DE and a blank period VBDAT between the frame periods is not maintained for a predetermined period. The external storing unit may store a minimum value and a maximum value of the period obtained by adding the frame period VDAT of the data enable signal DE and the blank period VBDAT. The fail detecting unit 620 may output the frame fail signal when the period obtained by adding the frame period VDAT of the data enable signal DE and the blank period VBDAT does not exist between the stored minimum value and maximum value.

The ESD line fail means when the data enable signal DE which is uniformly input is instantaneously changed due to, e.g., static electricity. The fail detecting unit 620 may output an ESD line fail signal, for example, when the frame period VDAT of the data enable signal DE is beyond the predetermined period.

The phase2 fail (or simply, P2 fail) is related with a three-dimensional (3D) image signal, and the phase2 fail means when a left image synchronization signal and a right image synchronization signal are not toggled for each frame. The fail detecting unit 620 may output a P2 fail signal when detecting the P2 fail.

Normally, the image processor 630 processes the image signals R, G, and B received from the graphic processing unit 10 in accordance with an operation condition of the display panel and generates and outputs the image data DAT. However, when the fail signal is received from the fail detecting unit 620, the image processor 630 outputs image data (hereinafter, referred to as “fail mode image data”) suitable for operating the display panel in the fail mode. As used herein, the “fail mode” means operating the display panel so that the display panel does not display a normal image but displays a separately prepared image (hereinafter, referred to as a fail image).

The fail mode image data may be image data predetermined in the signal controller 600, not normal image data based on the image signals R, G, and B. The data driver 500, when receiving the fail mode image data, drives the display panel to display not a normal image but a fail image. The fail mode image data may be differently configured according to the type of the fail signal received from the fail detecting unit 620. Accordingly, the display panel may display different fail images according to fail types.

The fail image may be a still image or a motion picture.

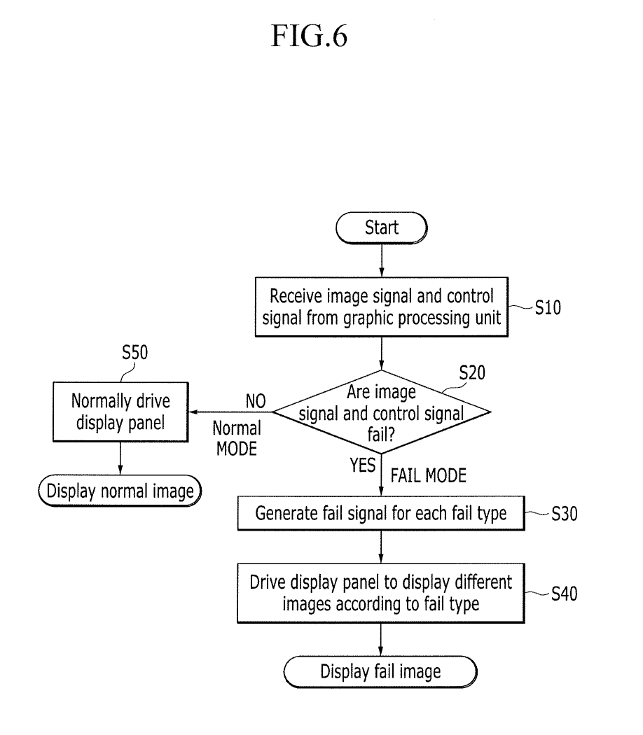

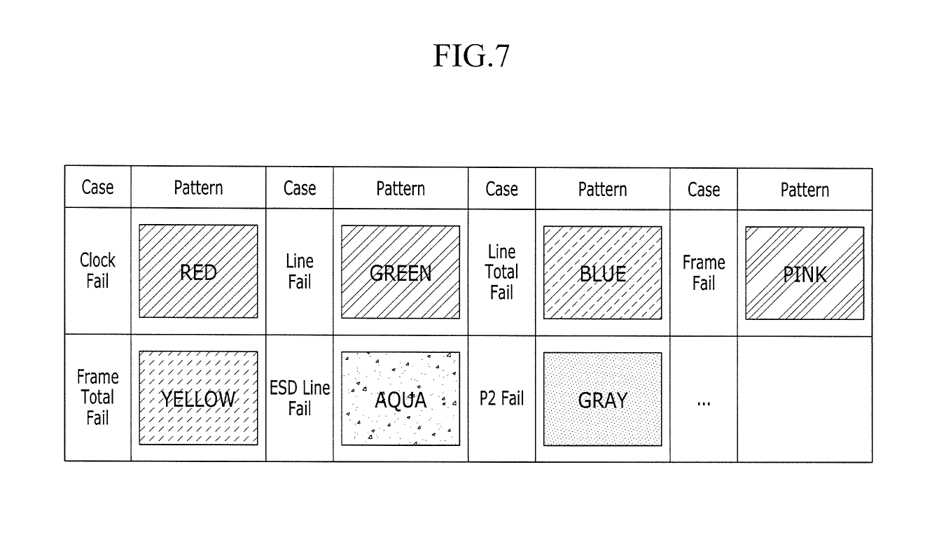

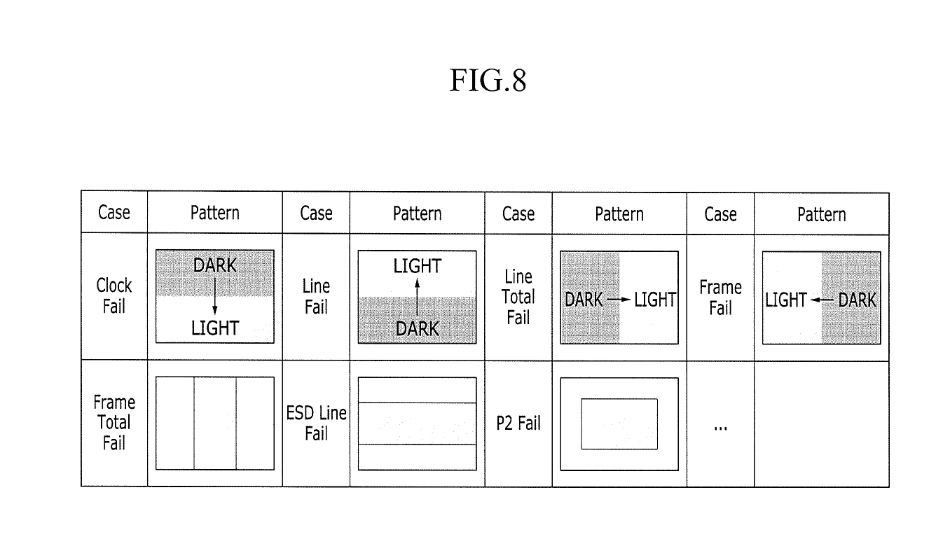

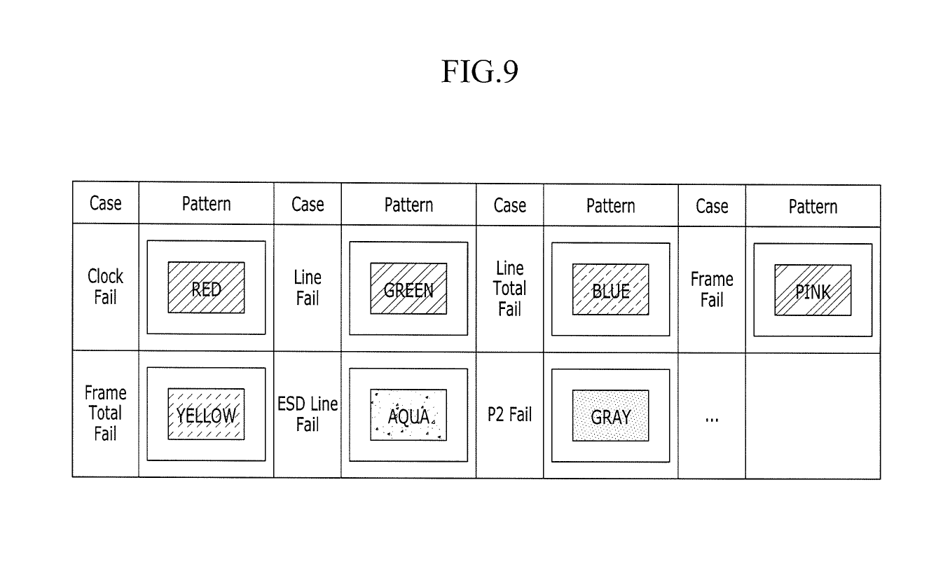

FIG. 6 is a flowchart illustrating a method in which a display device operates in a fail mode according to an exemplary embodiment of the present invention. FIG. 7 is a diagram illustrating an example of a display image for each fail type according to an exemplary embodiment of the present invention. FIG. 8 is a diagram illustrating an example of a display image for each fail type according to an exemplary embodiment of the present invention. FIG. 9 is a diagram illustrating an example of a display image for each fail type according to an exemplary embodiment of the present invention.

Steps S10 to S50 illustrated in FIG. 6 may be performed by the signal controller 600 of the display device 1.

The receiving unit 610 of the signal controller 600 receives the image signals R, G, and B and the control signal CONT from the graphic processing unit 10 (S10).

The fail detecting unit 620 of the signal controller 600 determines whether there is a fail in the image signals R, G, and B and the control signal CONT (S20), e.g., by comparing the image signals R, G, and B and the control signal CONT with reference data stored in an external memory. The external memory may be an Electrically Erasable Programmable Read-Only Memory (EEPROM).

When determining that there is the fail, the display device 1 operates in the fail mode. The fail detecting unit 620 generates a different fail signal for each fail type (S30).

The image processor 630 of the signal controller 600 receiving the fail signal does not process the image signals R, G, and B and drives the display panel 300 to display a different image for each fail type (S40), and the display panel 300 displays the fail image which may inform a user that there is the fail.

Examples of the different image per fail type are illustrated in FIGS. 7 to 9. FIG. 7 is an example of displaying still images having different colors according to fail types, FIG. 8 is an example of displaying still images having different patterns according to fail types, and FIG. 9 is an example of displaying still images having the same pattern and different colors according to fail types.

Referring to FIG. 7, when the image processor 630 receives the clock fail signal from the fail detecting unit 620, the line fail signal, the line total fail signal, the frame fail signal, the frame total fail signal, and the P2 fail signal, the entire screen of the display panel 300 may display a red image, a green image, a blue image, a pink image, an aqua image, and a gray image, respectively.

For example, when a red single colored image is displayed on the entire screen of the display panel, the user may notice that, among the fails, there is the clock fail. The displayed colors for indicating the respective fail types may be set to be different from what is described above in connection with FIG. 7.

Referring to FIG. 8, when a fail occurs, the colors may remain same, for example, in green, and a gradation may be shown from top to bottom or vice versa or from left to right or vice versa according to a fail type as shown in four upper images of FIG. 8, or a color is displayed at a part of the screen in a vertical direction or only in a part of the screen in a horizontal direction as shown in three lower images of FIG. 8, and thus, different images from each other depending on fail types may be noticed with the user's naked eyes. For example, when a long green image is displayed on the display panel in the vertical direction, the user may notice that there is the frame total fail even without a separate analysis process.

Referring to FIG. 9, a predetermined part of the screen is filled in a color, leaving the remaining part of the screen in another color such as white or black, thus forming a window pattern on the screen. The user may notice that a fail occurs from the window pattern.

According to an exemplary embodiment of the present invention, in addition to driving the display panel to display a different image for each fail type, the same pattern, for example, a black pattern or a BIST pattern rolling may be displayed regardless of the panel type. The display device 1 may further include a selection unit for selecting whether the display panel displays the black pattern or BIST pattern rolling. The BIST pattern rolling may mean that red, green, and blue still images are repetitively and alternately displayed at a predetermined interval.

Referring back to FIG. 6, when it is determined that there is no fail in the image signals R, G, and B and the control signal CONT (S20), the display device 1 operates in a normal mode. Accordingly, the image processor 630 generates image data DAT and control signals CONT1 and CONT2 based on the image signals R, G, and B and the control signal CONT to normally drive the display panel (S50).

Since the fail signal is generated in real-time, the fail signal is also generated in real-time. Accordingly, when the input signal is restored from an abnormal state, the fail detecting unit 620 does not detect the fail and thus stops generating the fail signal, and the display panel is thus back to the normal mode, therefore displaying the normal images based on the image data R, G, and B and the control signal CONT thereof.

While this invention has been shown and described in connection with exemplary embodiments thereof, it is to be understood by one of ordinary skill in the art that various changes in form and detail may be made thereto without departing from the spirit and scope of the present invention as defined by the following claims.

What is claimed is:

1. A display device, comprising:
a display panel; and
a signal controller configured to receive an input signal and configured to control an operation of the display panel;
wherein the signal controller is configured to control the display panel to display different images according to different types of a fail when determining that the input signal includes the fail.

2. The display device of claim 1, wherein the input signal includes an image signal and a control signal generated by a graphic processing unit.

3. The display device of claim 2, wherein the signal controller includes:
a receiving unit configured to receive the image signal and the control signal from the graphic processing unit;
a fail detecting unit configured to detecting the fail in the received image signal and control signal to generate a fail signal; and
an image processor configured to output image data in a fail mode when receiving the fail signal.

4. The display device of claim 3, wherein the fail signal has different types according to the different types of the fail.

5. The display device of claim 4, wherein the type of the fail includes a clock fail, a line fail, a line total fail, a frame fail, a frame total fail, an ESD line fail, or a phase2 fail.

6. The display device of claim 3, wherein the fail detecting unit includes a plurality of detecting units respectively configured to detect different types of fails to generate different fail signals, respectively.

7. The display device of claim 1, wherein the image includes a still image.

8. The display device of claim 7, wherein the image has different colors according to the different types of the fail.

9. The display device of claim 7, wherein the image has different patterns according to the different types of the fail.

10. The display device of claim 7, wherein the image has the same pattern and different colors according to the different types of the fail.

11. The display device of claim 1, wherein the image remains same regardless of the type of the fail.

12. A method of driving a display device including a display panel and a signal controller, the method comprising:
receiving an input signal by the signal controller;
detecting a fail in the input signal to generate a fail signal by the signal controller; and
controlling the display panel to display a image according to the type of the fail by the signal controller.

13. The method of claim 12, wherein the input signal includes an image signal and a control signal.

14. The method of claim 13, wherein detecting the fail in the input signal includes comparing the input signal with reference data stored in an external storing unit.

15. The method of claim 14, wherein the fail signal has different types according to the different types of the fail.

16. The method of claim 15, wherein the type of the fail includes a clock fail, a line fail, a line total fail, a frame fail, a frame total fail, an ESD line fail, or a phase2 fail.

17. The method of claim 12, wherein the image includes a still image.

18. The method of claim 17, wherein the image has different colors according to the different types of the fail.

19. The method of claim 17, wherein the image has different patterns according to the different types of the fail.

20. The method of claim 17, wherein the image has the same pattern and different colors according to the different types of the fail.
